(19) United States
(12) Patent Application Publication
(10) Pub. No.: US 2012/0014025 A1
(43) Pub. Date: Jan. 19, 2012

(54) OVERCURRENT PROTECTION CIRCUIT AND SEMICONDUCTOR DEVICE

(75) Inventors: Takuya SATO, Itami (JP); Takuma MURANUSHI, Itami (JP)

(73) Assignee: RENESAS ELECTRONICS CORPORATION

(21) Appl. No.: 13/181,751

(22) Filed: Jul. 13, 2011

(30) Foreign Application Priority Data
Jul. 14, 2010 (JP) 2010-159488

(51) Int. Cl. H02H 9/02

(52) U.S. Cl. 361/93.1

(57) ABSTRACT

The present invention is directed to achieve longer life of a driving element for driving a load without maintaining a stop state of the driving element even in the case where overcurrent occurs in the driving element. An overcurrent protection circuit monitors current flowing in driving elements for driving a load and, in the case where it is detected that the current becomes a predetermined threshold or larger, performs a control for stopping driving of the load only for predetermined protection time in accordance with a detection result. The overcurrent protection circuit counts the number of detection times and changes the predetermined protection time in accordance with the number of detection times.

### CROSS-REFERENCE TO RELATED APPLICATIONS

The disclosure of Japanese Patent Application No. 2010-159488 filed on Jul. 14, 2010 including the specification, drawings and abstract is incorporated herein by reference in its entirety.

### BACKGROUND

The present invention relates to an overcurrent protection circuit and a semiconductor device having the circuit and, more particularly, to a technique effectively applied to a drive circuit for driving a load.

A drive circuit, as a related art, for driving a load such as a motor or speaker has therein an overcurrent protection circuit for protecting a load and a switching element for driving the load at the time of driving the load and the like by stopping the operation of the switching element in the case where overcurrent flows in, for example, a power MOSFET or the like. The purpose is to prevent the product life from being shortened by destruction, deterioration, or the like of the switching element due to overcurrent flowed. An overcurrent protection circuit is disclosed in Japanese Unexamined Patent Publication No. Hei 9 (1997)-308261 (patent document 1).

In a drive circuit for driving a DC motor as a load by a switching element, when overcurrent flows in the switching element at the time of driving the load, the overcurrent protection circuit disclosed in the patent document 1 forcedly turns off the switching element only for preliminarily specified time, monitors the frequency of the turn-off and, when the frequency becomes equal to or higher than a predetermined degree, holds the off state.

### [Related-Art Document]

### [Patent Document]

Japanese Unexamined Patent Publication No. Hei 9 (1997)-308261

### SUMMARY

In the overcurrent protection circuit disclosed in the patent document 1, when the off state of the switching element is held, the off state cannot be cancelled as long as the power supply is turned on again. It causes a problem, for example, when the load is a speaker. For example, in the field of audio devices, even in the case where overcurrent flows in the switching element at the time of driving the load, the state where sound is not output is not maintained but it is requested to automatically restore the switching element. In the overcurrent protection circuit disclosed in the patent document 1, although the switching element can be protected, automatic restoration cannot be performed. Consequently, the request is not satisfied.

An object of the present invention is to increase the life of a driving element for driving a load by not holding a stop state of the driving element even in the case where overcurrent occurs in the driving element.

The above and other objects and novel features of the present invention will become obvious from the description of the specification and the appended drawings.

Outline of representative one of inventions disclosed in the application will be briefly described as follows.

An overcurrent protection circuit monitors current flowing in a driving element for driving a load and, in the case where it is detected that the current becomes equal to or larger than a predetermined threshold, performs a control for stopping the driving of the load only for predetermined protection time in accordance with a detection result. The overcurrent protection circuit counts the number of times of the detection and changes the predetermined protection time in accordance with the number of times of the detection.

An effect obtained by the representative one of the inventions disclosed in the application will be briefly described as follows.

The overcurrent protection circuit does not hold the stop state of the driving element even in the case where overcurrent occurs in the driving element for driving the load, so that the longer life of the driving element is realized.

### BRIEF DESCRIPTION OF THE DRAWINGS

FIG. 1 is a block diagram showing an example of the configuration of a driving apparatus 1 having an overcurrent protection circuit 10 according to a first embodiment.

FIG. 2 is an explanatory diagram showing an example of a state where overcurrent occurs.

FIG. 3 is an explanatory diagram showing a procedure of processes related to overcurrent detection in the driving apparatus 1.

FIG. 4 is an explanatory diagram showing a sequence in the case where overcurrent detection is performed in search periods.

FIG. 5 is an explanatory diagram showing a sequence in the case where overcurrent detection is performed out of the search periods.

FIG. 6 is a block diagram showing an example of the configuration of a driving apparatus 2 having an overcurrent protection circuit 12 according to a second embodiment.

FIG. 7 is an explanatory diagram showing an example of a timing of outputting a sound signal.

FIG. 8 is an explanatory diagram showing an example of search periods 1 and 2.

FIG. 9 is an explanatory diagram showing a sequence in the case where overcurrent detection is performed in the search period 1.

FIG. 10 is an explanatory diagram showing a sequence in the case where overcurrent detection is performed in the search period 2.

### DETAILED DESCRIPTION

### 1. Outline of Embodiments

First, outline of representative embodiments of the present invention disclosed in the application will be described. Reference numerals in parenthesis in the drawings which are referred to in the description of the outline of representative embodiments just illustrate components included in the concept.

### (1) (Time Since Detection of Overcurrent Until Restoration is Changed According to the Number of Detection Times)

An overcurrent protection circuit (10) according to a representative embodiment of the invention has: a current detecting unit (101_A, 101_B) that monitors current flowing in a driving element (301 to 304) for driving a load (2) and detects current which is equal to or larger than a predetermined threshold; and a control unit (102) that performs control for stopping driving of the load for only predetermined protection time in accordance with a detection result of the current detecting unit. The control unit counts the number of times of performing the detection and changes the predetermined protection time (protection time 1) in accordance with the number of detection times.

With the configuration, in the case where overcurrent flows in the driving element, the driving element is protected for only predetermined protection time. Consequently, the driving element can automatically restore from the protection state without maintaining the state where the driving of the load is stopped. By counting the number of times of detecting overcurrent, the frequencies of occurrence of the abnormal state in which overcurrent occurs can be grasped. Therefore, the possibility that the abnormal state is cancelled can be grasped, and the protection time can be changed according to the possibility that the abnormal state is cancelled.

(2) (Restoration Time is Increased when Detection is N Times)

In the overcurrent protection circuit of (1), when the number of detection times becomes N times (N is an integer of 1 or larger), the control unit (102, 103) changes to extend the predetermined protection time.

As described above, even in the case where the abnormal state in which overcurrent occurs continues, the state where the driving of the load is stopped is not maintained in the overcurrent protection circuit of (1), so that protection of the driving element on detection of overcurrent and restoration from the protection state are repeated. In such a case, overcurrent flows to the driving element each time the driving element restores from the protection state. In the overcurrent protection circuit of (2), when the number of times overcurrent is detected becomes N times, it is determined that the possibility that the abnormal state is cancelled is low. By extending the time of protecting the driving element, the frequency that overcurrent flows in the driving element can be reduced. In the case where the load is a speaker, the frequency of occurrence of abnormal sound caused by the overcurrent can be reduced.

### (3) (Count-Up of Detection in Search Period)

In the overcurrent protection circuit of (1) or (2), when the detection is performed in a search period (TS) for monitoring the detection, the control unit (102, 103) counts up the number of detection times.

### (4) (Search Period is Predetermined Period After Cancellation of Stop)

In the overcurrent protection circuit of (3), the search period is a predetermined period after lapse of the predetermined protection time.

In the case where the abnormal state in which overcurrent occurs is not cancelled, the possibility that the overcurrent is repeatedly detected in the predetermined time after restoration from the protection state is high. In consideration of this point, in the overcurrent protection circuit, by counting the number of times of detection of overcurrent generated in a predetermined period after restoration from the protection state, whether the abnormal state in which overcurrent occurs is cancelled or not can be grasped. In the case where the abnormal state is not cancelled, the frequency that overcurrent flows in the driving element can be reduced.

### (5) (Registers)

The overcurrent protection circuit of (3) or (4) further includes: a first register (104) in which predetermined time is set; a second register (105) in which time longer than the predetermined time in the first register is set; and a third register (106) in which the search period is set, and the first, second, and third registers can be set from the outside.

With the configuration, the protection time in which the driving of the load is stopped, the protection time after the change, and the search period can be set to desired values.

### (6) (When the Number of Detection Times Becomes N, Restoration Time is Extended)

In the overcurrent protection circuit of (5), when the number of detection times is less than N, the control unit determines the predetermined protection time in accordance with a value in the first register and, when the number of detection times becomes N, the control unit determines the predetermined protection time in accordance with a value in the second register.

With the configuration, the protection time can be easily changed.

### (7) (Driver IC)

A semiconductor device (1) according to a representative embodiment of the present invention has a driving element (301 to 304) for driving a load (2), and an overcurrent protection circuit according to any of (1) to (6), for controlling operation of the driving element in accordance with current flowing in the driving element.

With the configuration, the function of the overcurrent protection circuit of any of (1) to (6) can be realized in the driver IC for driving a load.

### (8) (Mute Period and Signal Output Period are Detected Distinctly)

An overcurrent protection circuit (12) includes: a current detecting unit (101_A, 101_B) that monitors current flowing in a driving element (301 to 304) for driving a load (2) and detects current which is equal to or larger than a predetermined threshold; and a control unit (122) that controls operation of the driving element in accordance with a detection result of the current detecting unit. The control unit performs a control for stopping the operation of the driving element for only predetermined protection time (protection time 1) when the detection is performed, changes the predetermined time (protection time 2) in accordance with the number of times the detection is performed in a first search period (search period 1 (TS1)) provided to stop driving the load after lapse of the predetermined protection time, and adjusts drivability of the driving element in accordance with the number of times the detection is performed in a second search period (search period 2 (TS2)) after lapse of the first search period.

In the case where the overcurrent detection is performed in the first search period provided to stop driving of the load after lapse of the protection time for stopping the operation of the driving element, for example, in a mute period in which a sound signal is not output in the case where the load is a speaker, powering or grounding of a load terminal is considered to be the cause of occurrence of the overcurrent. The cause of overcurrent in the second search period after lapse of the first search period is considered to be, not powering or grounding of the load terminal, but impedance drop such as short-circuiting between load terminals or input of an excessive signal. In the overcurrent protection circuit of (8), the number of times overcurrent is detected in each of the first and second search periods is grasped, so that the cause of occurrence of overcurrent can be grasped. Further, in the overcurrent protection circuit of (8), without holding the state where the operation of the driving element is stopped, protection of the driving element can be optimized according to the cause of occurrence of overcurrent.

### (9) (When the Number of Detection Times Becomes N in Mute Period, Restoration Time is Extended)

In the overcurrent protection circuit of (8), when the number of detection times in the first search period becomes N times (N is an integer of 1 or larger), the control unit (122, 123) changes to extend the predetermined protection time.

With the configuration, in the case where the cause of occurrence of overcurrent is, for example, powering or grounding of the load terminal, in a manner similar to (2), the frequency that overcurrent flows in the driving element can be reduced. In the case where the load is a speaker, the frequency of occurrence of abnormal sound caused by overcurrent can be reduced.

### (10) (When the Number of Detection Times in Second Search Period is M, Output Level is Adjusted)

In the overcurrent protection circuit of (8) or (9), when the number of detection times in the second search period becomes M times (M is an integer of 1 or larger), the control unit (122) performs a control, of regulating the drivability of the driving element.

With the configuration, in the case where the cause of occurrence of overcurrent is, for example, impedance drop such as short-circuiting between load terminals or input of an excessive signal, by regulating the drivability of the driving element, the driving element can be protected without stopping the driving of the load. In the case where the load is a speaker, occurrence of abnormal sound caused by overcurrent can be prevented.

### (11) (Output Level Control is Control on Gain)

In the overcurrent protection circuit of (10), the control of regulating the drivability of the driving element is a control of lowering level of a signal for driving the driving element.

With the configuration, in the case where a signal for driving the driving element is an analog signal, by lowering the gain of the signal, the drivability of the driving element can be regulated.

### (12) (Output Level Control is Control on Change in Duty Ratio)

In the overcurrent protection circuit of (10), the control of regulating the drivability of the driving element is a control of reducing fluctuation width of a pulse width of a signal which is supplied to the driving element.

With the configuration, in the case where the method of driving the driving element is PWM (Pulse Width Modulation) control, by regulating the fluctuation width of a pulse, the drivability of the driving element can be regulated.

(13) (Restoration Time and the Like can be Set from the Outside)

The overcurrent protection circuit of any of (8) to (12) further includes: a first register (104) in which predetermined time is set; a second register (105) in which time longer than the predetermined time in the first register is set; a third register (106) in which the first search period is set; and a fourth register (107) in which the second search period is set. The first, second, third, and fourth registers can be set from the outside.

With the configuration, the protection time in which the driving of the load is stopped, the protection time after change, and the first and second search periods can be set to desired values.

### (14) (When the Number of Detection Times is N, Restoration Time is Extended)

In the overcurrent protection circuit of (13), when the number of detection times is less than N, the control unit determines the predetermined protection time in accordance with a value in the first register and, when the number of detection times becomes N, the control unit determines the predetermined protection time in accordance with a value in the second register.

With the configuration, the protection time can be easily changed.

A semiconductor device (4) according to a representative embodiment of the invention has a driving element (301 to 304) for driving a load (2), and an overcurrent protection circuit of any of (8) to (14) for controlling operation of the driving element in accordance with current flowing in the driving element.

With the configuration, in the driver IC for driving a load, the function of the overcurrent protection circuit of any of (8) to (14) can be realized.

### 2. Details of Embodiments

Embodiments will be described more specifically.

### First Embodiment

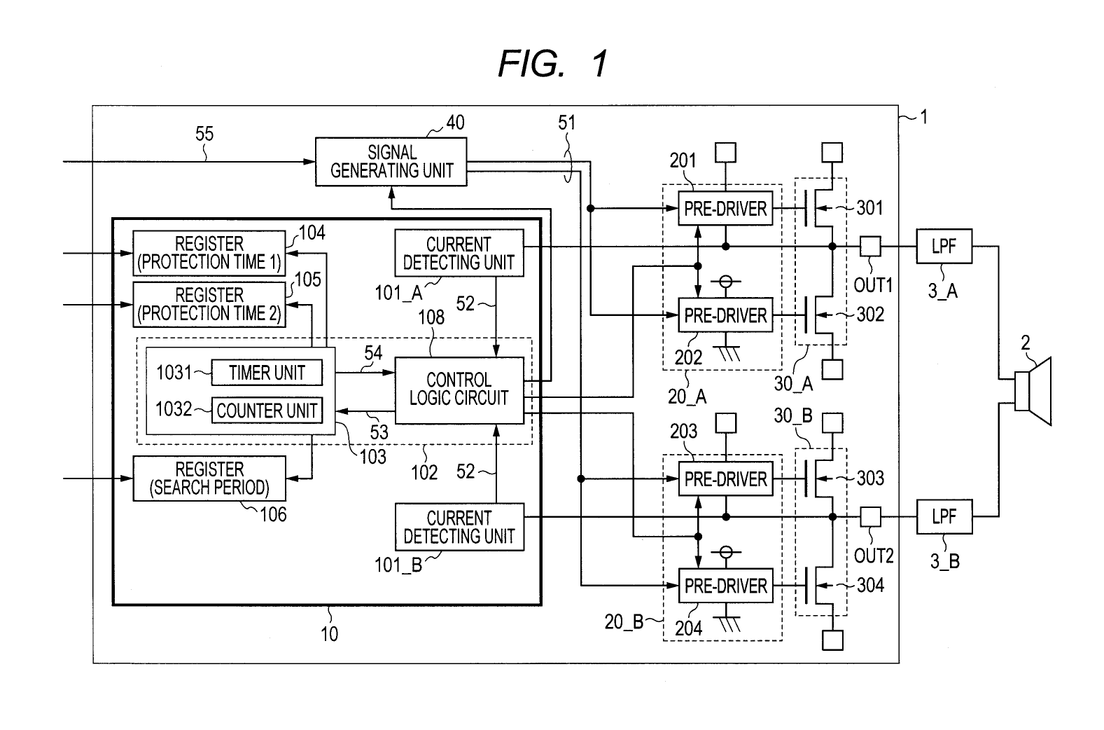

FIG. 1 is a block diagram showing an example of the configuration of a speaker driving apparatus having an overcurrent protection circuit according to a first embodiment. A driving apparatus 1 shown in the diagram is, although not limited, formed on a semiconductor substrate such as a single-crystal silicon by the known CMOS integrated circuit manufacturing technique.

The driving apparatus 1 is, for example, a driver circuit for driving a speaker 2 via LPFs (Low-Pass Filters) 3_A and 3_B by performing PWM and class-D operation on a sound signal. The driving apparatus 1 has a signal generating unit 40, the overcurrent protection circuit 10, pre-driver units 20_A and 20_B, and output units 30_A and 30_13.

The signal generating unit 40 performs pulse width modulation (PWM) on an input sound signal and supplies generated digital signals 51 to the pre-driver units 20_A and 20_B.

Pre-drivers 201 to 204 are buffer circuits for driving the output units 30_A and 30_B and drive the output units 30_A and 30_B on the basis of the digital signals 51 received from the signal generating unit 40.

The output units 30_A and 30_B are driving elements for driving the speaker via the LPFs 3_A and 3_B and drive the speaker as a load in accordance with the digital signals 51 supplied via the pre-drivers 201 to 204. The output units 30_A and 30_B have, for example, MOS transistors 301 and 303 on the high-side and MOS transistors 302 and 304 on the low side, respectively.

The driving apparatus 1 has an overcurrent protection function of, at the time of driving the speaker 2 as described above, monitoring current flowing in the MOS transistors 301 to 304 as driving elements of the speaker 2 and, when overcurrent is detected, controlling the driving of the MOS transistors 301 to 304 by the pre-driver units 20_A and 20_B to protect the MOS transistors 301 to 304, the speaker 2, and the like. In the following, the overcurrent protection function will be described together with the operation of related function units.

The overcurrent protection operation in the driving apparatus 1 is controlled by the overcurrent protection circuit 10. The overcurrent protection circuit 10 has current detecting units 101_A and 101_B, a control unit 102, and registers 104 to 106.

First, the basic operation performed on detection of overcurrent will be described. When current larger than a predetermined threshold flows in the MOS transistor 301 or 302 in the output unit 30_A, the current detecting unit 101_A monitoring current flowing in the MOS transistor 301 or 302 in the output unit 30_A outputs a detection signal 52. For example, in the case where the predetermined threshold is 8 [A], when current flowing in the MOS transistor 301 on the high side exceeds 8 [A] at the time of driving the speaker, the current detecting unit 101_A notifies of occurrence of overcurrent by outputting the detection signal. In a method of detecting the overcurrent, although not limited, for example, whether overcurrent occurs or not is determined by generating current corresponding to the current flowing in the MOS transistor 301 or 302, converting the generated current to voltage, and comparing the converted voltage with a predetermined threshold, whether overcurrent occurs or not is determined by providing a resistor for a path of current flowing in the MOS transistor 301 or 302, measuring a voltage across the ends of the resistor, and comparing the measured voltage with a predetermined threshold, or whether overcurrent occurs or not is determined by directly measuring voltage at an output terminal OUT1 and comparing it with a predetermined threshold. In a manner similar to the current detecting unit 101_A, the current detecting unit 101_B also monitors current flowing in the MOS transistor 301 or 302 in the output unit 30_B and detects overcurrent.

The control unit 102 has a control logic circuit 108 and a sequence counter unit 103. When detection of overcurrent is performed by the current detecting units 101_A and 101_B, the control logic circuit 108 which receives the detection signal 52 controls the operation of function units and starts the operation of protecting the MOS transistors 301 to 304, the speaker 2, and the like. Concretely, when the control logic circuit 108 receives the detection signal 52 from the current detecting unit 101_A or 101_B, the control logic circuit 108 controls the pre-driver 201 to 204 to stop the operation of the MOS transistors 301 to 304. It makes output terminals OUT1 and OUT2 enter a high-impedance (Hi-Z) state, and the driving of the speaker stops. At this time, the control logic circuit 108 controls the operation of the signal generating unit 40 as necessary and stops outputting the signals to the pre-drivers 201 to 204. Further, the control logic circuit 108 controls to stop the operation of the MOS transistors 301 to 304 and outputs a protection start signal 53 indicative of start of protection to the sequence counter unit 103. The sequence counter unit 103 which receives the protection start signal 53 starts counting a period of stopping the operation of the MOS transistors 301 to 304 (hereinbelow, also called “protection time”) by a timer unit 1031 internally provided. The sequence counter unit 103 has the timer unit 1031 and a counter unit 1032, and the timer unit 1031 has a plurality of timer circuits for measuring set time. In the timer unit 1031, for example, protection time is pre-set by the sequence counter unit 103, and time is measured by down-counting the pre-set protection time. The sequence counter unit 103 pre-sets, for example, a value of the register 104 in which time information is set as protection time 1 into the timer unit 1031. For example, in the case where time information of 1 [s] is set in the register 104, the timer unit 1031 measures time of 1 [s]. In the register 104, a value can be set from a host device on the outside.

On completion of measurement of the protection time by the timer unit 1031, the sequence counter unit 103 outputs a restorable signal 54 indicating that the protection state of the MOS transistors 301 to 304 can be cancelled. The control logic circuit 108 which receives the restorable signal 54 controls the pre-drivers 201 to 204 to cancel the protection state of the MOS transistors 301 to 304. As a result, the driving apparatus 1 returns to a state where the normal operation can be performed.

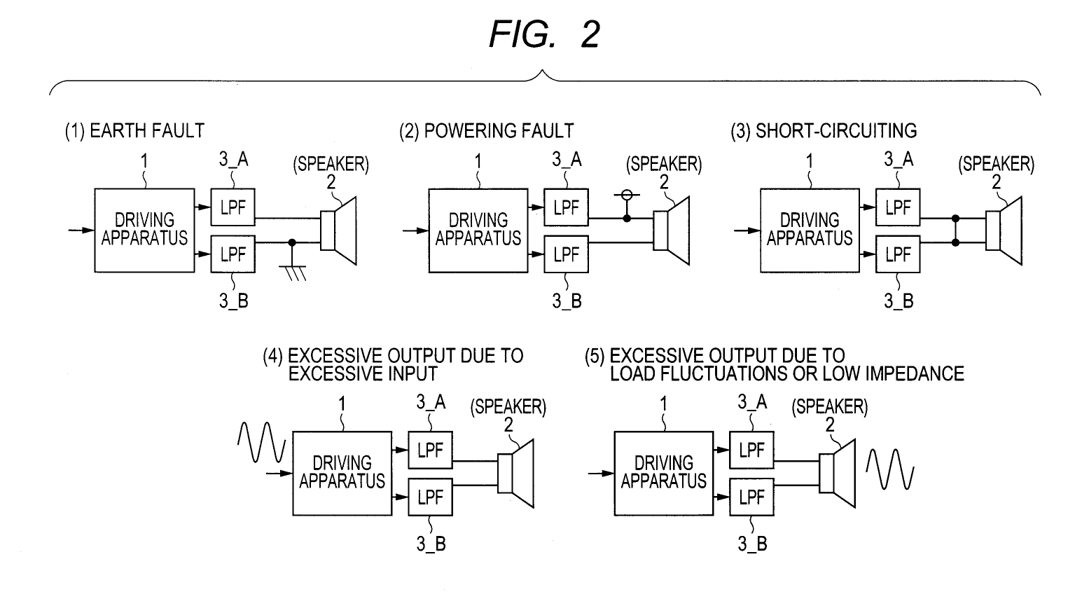

As described above, when overcurrent occurs in the MOS transistors 301 to 304, the driving apparatus 1 performs the operation for protecting the MOS transistors 301 to 304, the speaker 2, and the like by the above-described method. A state having high possibility of occurrence of the overcurrent is, for example, a state shown in FIG. 2.

FIG. 2 is an explanatory diagram showing an example of a state where overcurrent occurs in a speaker driving system including the driving apparatus 1.

As shown in FIG. 2, overcurrent occurs in a state where wiring lines coupled to the output terminals OUT1 and OUT2 of the driving apparatus 1 are powered or grounded due to a fault or the like of a product substrate. In this case, the load of the output unit 30_A or 30_B is the LPF 3_A or 3_B, so that the possibility that overcurrent flows is high. Also in the case where the load terminal is short-circuited, the output units 30_A and 30_B become loads to each other, so that the possibility of occurrence of overcurrent at the time of outputting a sound signal is high. Other cases of occurrence of overcurrent include a case where an excessive sound signal is input to the driving apparatus 1, a case where an end user couples a speaker having low impedance by mistake, and a case where impedance drops due to failure of the speaker 2 or the like.

In those states, in the powering fault state, the earth fault state, and the short-circuit state of the load terminals, the possibility that the abnormal state is cancelled within protection time of a few seconds is low. Consequently, the driving apparatus 1 according to the first embodiment has the function of counting the number of times overcurrent is detected within a predetermined period after cancellation of the protecting operation and changing the protection time in accordance with the number of detection times. The function will be described specifically below.

When the overcurrent is detected and the protection operation is cancelled after lapse of predetermined protection time as described above, the sequence counter unit 103 starts measuring a period TS for searching whether overcurrent detection is performed again or not (hereinbelow, called “search period”) by using the timer unit 1031. For example, predetermined time is preset as a search period by the sequence counter unit 103 and the timer unit 1031 measures time by down-counting the preset time. The sequence counter unit 103 presets, for example, the value of the register 106 in which time information is set as the search period TS into the timer unit 1031. For example, in the case where time information of 10 [ms] is set in the register 106, the timer unit 1031 measures time of 10 [ms] as the search period TS. A value can be set from the outside in the register 106 like another register 104 and the like.

When overcurrent occurs again in the search period TS and the protection start signal 53 is output from the control logic circuit 108, the sequence counter unit 103 measures the number of detection times. Concretely, the sequence counter unit 103 has therein the counter unit 1032, and the counter unit 1032 counts the number of times of the protection start signals 53 which are output in the search period TS and holds the number of detection times. For example, when the overcurrent is detected in the normal operation of the driving apparatus 1, the driving apparatus 1 shifts to the protection operation state as described above and, after lapse of the protection time, restores to the normal operation. However, in the case where the overcurrent is detected again in the search period TS after the restoration, the counter unit 1032 counts the number of detection times, sets the number of detection times as “twice”, and holds the information.

As described above, the sequence counter unit 103 monitors whether overcurrent is detected or not in the search period TS and counts the number of detection times each time the protection operation state is cancelled. When the number of detection times reaches the predetermined number of times, the sequence counter unit 103 changes to extend the protection time. Concretely, when the number of detection times held in the counter unit 1032 becomes N times (N is an integer of 1 or larger), the sequence counter unit 103 changes the protection time to be preset in the timer unit 1031. For example, when the number of detection times counted by the counter unit 1032 becomes eight times, the sequence counter unit 103 changes the register storing protection time to be referred to from the register 104 to the register 105 in which information of time longer than that in the register 104 is set, and presets a value of the register 105 as protection time 2 into the timer unit 1031. For example, in the case 1 [s] is set as the protection time 1 in the register 104 and 4 [s] is set as protection time 2 in the register 105, when the number of detection times becomes eight, the protection time measured by the timer unit 1031 is changed from 1 [s] to 4 [s]. In the register 105 as well, like in the register 104 and the like, a value can be set from the outside.

As described above, in the case where the abnormal state in which overcurrent is generated is not improved even after lapse of a predetermined time, the driving apparatus 1 extends the protection time and repeatedly executes switching between the protection operation state and the normal operation state until the abnormal state is improved.

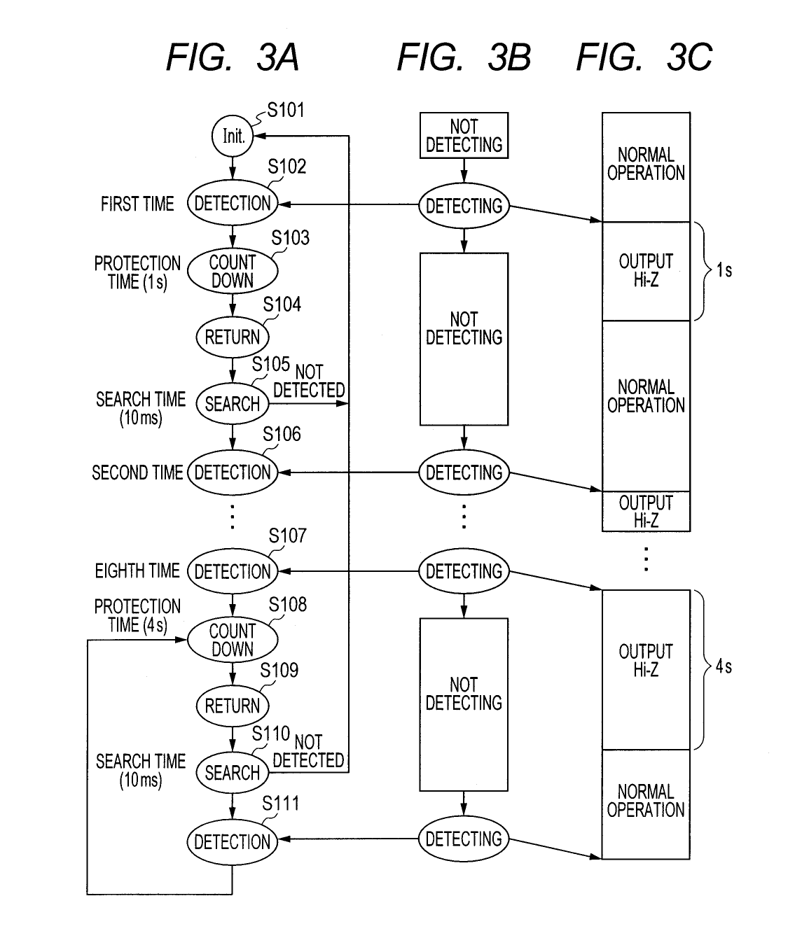

The flow of processes related to the above-described overcurrent detection will be described in detail with reference to FIG. 3.

FIG. 3 is an explanatory diagram showing a procedure of processes related to overcurrent detection in the driving apparatus 1.

In FIG. 3, reference numeral (A) indicates a diagram showing a state of the sequence counter unit 103. Reference numeral (B) indicates a diagram showing a state of the current detecting unit 101_A or 101_B. Reference numeral (C) indicates a diagram showing a state of the output unit 30_A or 30_B. The timings of processes in the diagrams (A) to (C) are made correspond to each other.

As shown in FIG. 3, a state where overcurrent is not detected in the normal operation of the driving apparatus 1 is set as the initial state, and the operation state of the sequence counter unit 103 in the initial state is set as the initial state (S101). As an example, the protection time initially set is 1 [s], the protection time after change is 4 [s], and the number of detection times in which the protection time is changed is eight.

First, when overcurrent is detected (S102) in the initial state (S101), the sequence counter unit 103 starts counting the protection time by the timer unit 1031 in response to the protection start signal 53 (S103). The control logic circuit 108 controls the pre-drivers 201 to 204 to stop the operation of the MOS transistors 301 to 304, to make the operation shift to the protection operation. As a result, an output enters a high impedance state.

On completion of the protection time (one second), the sequence counter unit 103 outputs the restorable signal 54 (S104). The control logic circuit 108 cancels the protection state and shifts to the normal operation. At this time, the sequence counter unit 103 starts measurement in the search period TS after cancellation of the protection state by using the timer unit 1031 (S105). In the case where overcurrent is not detected in the search period TS in step S105, the program returns to step S101 where the driving apparatus 1 enters the initial state. On the other hand, when overcurrent is detected in the search period TS and the protection start signal 53 is output, the sequence counter unit 103 counts up the number of detection times by using the counter unit 1032 (S106). For example, in the case shown in FIG. 3, the overcurrent detection is performed once in step S102, the number of detection times in step S106 is “twice”. After that, processes similar to those in steps S103 to S106 are performed. When the number of detection times becomes eight, the sequence counter unit 103 changes the protection time from 1 [s] to 4 [s] and starts counting the protection time (four seconds) by the timer unit 1031 (S108). On completion of counting of the protection time (four seconds), the sequence counter unit 103 outputs the restorable signal 54 (S109). It makes the control logic circuit 108 cancel the protection state and shift to the normal operation. Like in step S105, the sequence counter unit 103 starts measuring the search period TS by using the timer unit 1031 (S110). In the case where overcurrent detection is not performed in the search period TS in step S110, the program returns to step S101 and sets the initial state. At this time, the sequence counter unit 103 changes the register in which information of protection time is set and which is referred to from the register 105 (4 [s]) to the register 104 (1 [s]), and presets the value of the register 104 (1 [s]) into the timer unit 1031. On the other hand, in the case where overcurrent detection is performed in the search period TS (S111), the program shifts to the step S108 and repeats processes similar to the above.

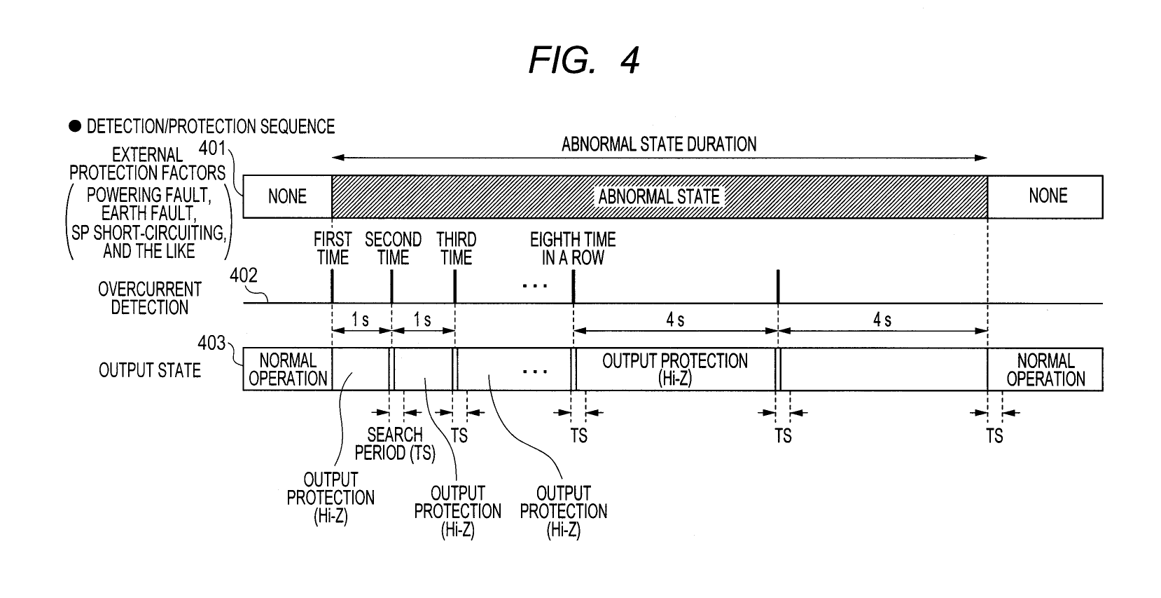

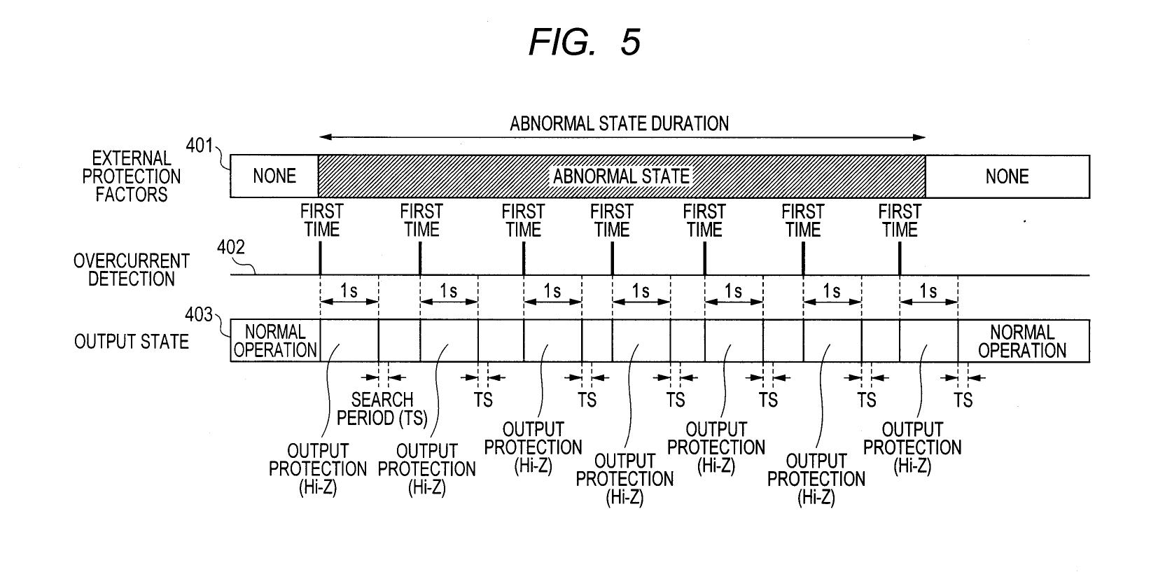

FIGS. 4 and 5 show examples of the sequence at the time of overcurrent detection in the driving apparatus 1.

FIG. 4 is an explanatory diagram showing a sequence in the case where overcurrent detection is performed in the search periods TS.

Reference numeral 401 indicates the presence or absence of an abnormal state in which overcurrent due to powering fault, earth fault, short-circuiting across load terminals, or the like may occur. Reference numeral 402 indicates the timing of overcurrent detection according to the presence/absence of the abnormal state. Reference numeral 403 indicates the output state of the driving apparatus 1 according to the presence/absence of the abnormal state. Although the diagram shows, as an example, the case where the protection time 1 is 1 [s] and the protection time 2 is 4 [s], the invention is not limited to the case.

As shown in the diagram, by the overcurrent detection in the search periods TS, shift to the protection operation state of one second and restoration to the normal operation are repeatedly executed. After the overcurrent detection in the search period TS of the eighth time, the protection time of the protection operation state is changed from one second to four seconds.

FIG. 5 is an explanatory diagram showing a sequence in the case where overcurrent detection is performed out of the search periods TS.

As shown in the diagram, by the overcurrent detection, shift to the protection operation state of one second and restoration to the normal operation are repeatedly executed. However, detection is performed out of the search periods TS, so that the protection time is not switched.

Although not shown, also in the case where overcurrent detection is performed on the outside of the search periods, if the abnormal state is not improved in predetermined number of times, the protection time may be switched.

In the driving apparatus 1 having the overcurrent protection according to the first embodiment, in the case where overcurrent flows in the MOS transistors 301 to 304, the operation of the output unit 30_A or 30_B is stopped only for protection time. Consequently, without maintaining the state where driving of the load is stopped, the apparatus can be automatically restored from the protection state. The frequency of the abnormal state in which overcurrent is generated is grasped by counting the number of times of detecting the overcurrent and, in the case where the abnormal state in which the overcurrent is generated is not improved even after lapse of a predetermined period, by extending the protection time, the frequency of flowing the overcurrent can be suppressed even instantaneously. Thus, the driving apparatus 1 contributes to suppression of shortening of the product life of the MOS transistors 301 to 304 and reduction in the frequency of occurrence of abnormal sound in the speaker 2 due to overcurrent generation while having the function of automatic restoration from the overcurrent protection state.

### Second Embodiment

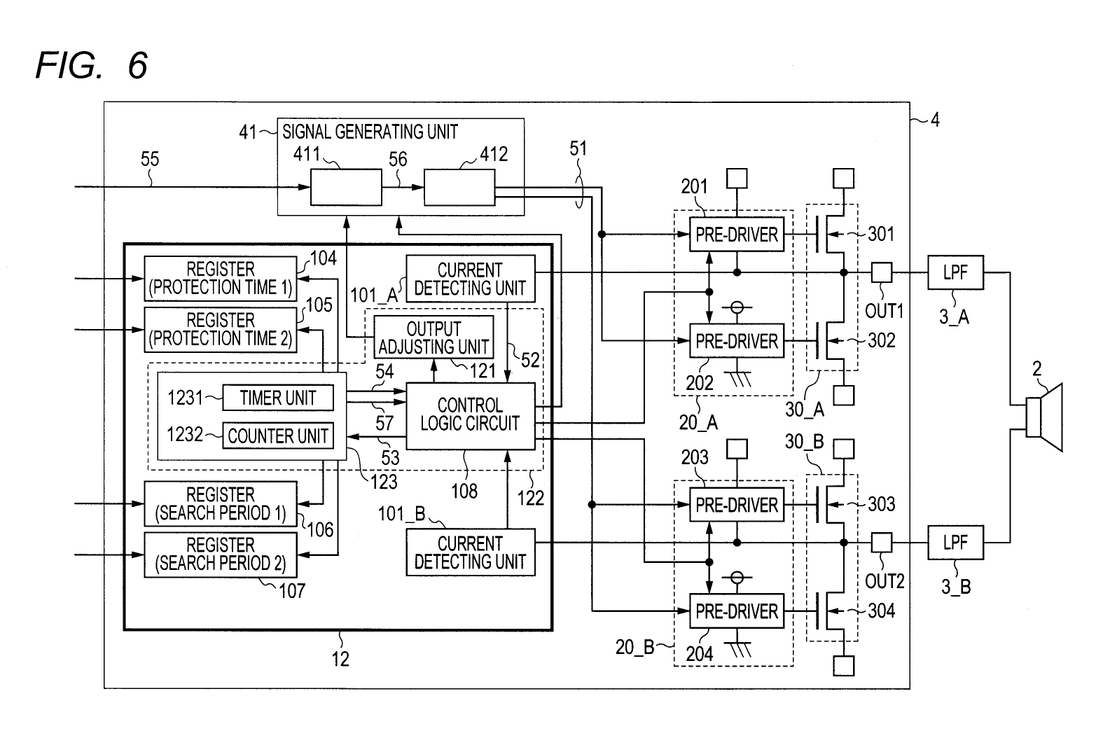

FIG. 6 is a block diagram showing an example of the configuration of a driving apparatus of a speaker, having an overcurrent protection circuit according to a second embodiment. The driving apparatus 2 shown in the diagram has the overcurrent protection function like the driving apparatus 1 according to the first embodiment and, further has the functions of optimizing a protection method in accordant with a timing overcurrent occurs.

The driving apparatus 2 is, although not limited, formed on a semiconductor substrate such as a single-crystal silicon by the known CMOS integrated circuit manufacturing technique. The same reference numerals are designated to components in the driving apparatus 2 shown in the diagram, which are similar to those in the driving apparatus 1, and their detailed description will not be repeated.

The driving apparatus 2 has a signal generating unit 41, an overcurrent protection circuit 12, the pre-driver units 20_A and 20_B, and the output units 30_A and 30_B.

The signal generating unit 41 has an amplifier unit 411 and a PWM control unit 412. For example, when an analog sound signal 55 is input from the outside, the amplifier unit 411 amplifies the input signal 55 and the PWM control unit 412 generates the digital drive signal 51 for driving the speaker 2 on the basis of an amplified sound signal 56 and outputs it to the pre-drivers 201 to 204.

The overcurrent protection circuit 12 has, in addition to the components of the overcurrent protection circuit 10 according to the first embodiment, a register 107 in which time information of the search period 2 to be described later is set and an output adjusting unit 121 in a control unit 122. The protection operation by the overcurrent protection circuit 12 will be described below.

The basic operation performed on detection of overcurrent is similar to that of the overcurrent protection circuit 10 according to the first embodiment. Specifically, when overcurrent is detected by the overcurrent protection circuit 12, the driving apparatus 2 shifts to the protection operation state and, after lapse of predetermined protection time, restores to normal operation. The function different from that of the overcurrent protection circuit 10 according to the first embodiment is as follows. In the overcurrent protection circuit 10, the search period TS is provided after restoration to the normal operation state, and the protection time is changed according to the number of times overcurrent is detected in the search period TS. In the overcurrent protection circuit 12 according to the second embodiment, two search periods of the search period 1 (TS1) and the search period 2 (TS2) are provided after restoration to the normal operation state. The number of times overcurrent is detected is counted in each of the search periods, and the protection method is changed according to each of the numbers of detection times.

First, the search period 1 (TS1) and the search period 2 (TS2) will be described.

As described above with reference to FIG. 2, the abnormal states considered as causes to occurrence of overcurrent include powering fault, earth fault, and drop in impedance such as short-circuiting across load terminals. Overcurrent caused by the powering fault and earth fault can occur even when no sound signal is output. For example, in the case of driving a speaker by a class-D operation, even when the sound signal is not output, a mute period in which the MOS transistors 301 to 304 in the output units 30_A and 30_B perform the switching operation by a PWM drive signal having a duty ratio of 50% exists, and overcurrent may be generated in the period.

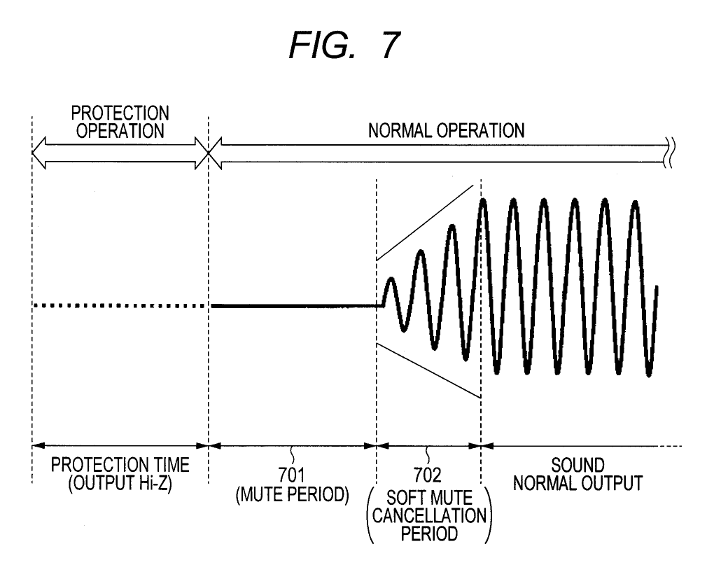

FIG. 7 is an explanatory diagram showing an example of a timing of outputting a sound signal.

As shown in the diagram, a predetermined period after cancellation of the protection operation state by detection of overcurrent is a mute period 701 in which no sound signal is output. After lapse of the mute period 701, the state shifts to a state where a sound signal can be output. A predetermined period after cancellation of the mute period 701 is a soft mute cancellation period 702 for preventing popping sound, in which the gain of the sound signal is gradually changed to a target gain. After the soft mute cancellation period 702, the sound signal is output with a specified gain.

As described above, in the case where the abnormal state is a powering fault state or an earth fault state, even in the mute period in which no sound signal is output, the MOS transistors 301 to 304 perform the switching operation by a drive signal having a duty ratio of 50%, overcurrent occurs. On the other hand, in the case where the abnormal state is a low impedance state such as a short-circuiting state or an excessive input state, an output signal having a duty ratio of 50% is smoothed by the LPFs 3_A and 3_B in the mute period, and the smoothed voltage is applied across the speaker 2. Consequently, no current flows in the speaker 2 and no overcurrent occurs. Therefore, in the second embodiment, the same period as the mute period is set as the search period 1 (TS1). In the case where overcurrent is detected in the search period 1, it is determined that the powering fault state or the earth fault state is the cause of occurrence of overcurrent. In the case where a predetermined period after cancellation of the mute period is set as the search period 2, no overcurrent is detected in the search period 1, and overcurrent is detected in the search period 2, it is determined that the low-impedance state such as short-circuiting across the load or the excessive input state is the cause of occurrence of overcurrent.

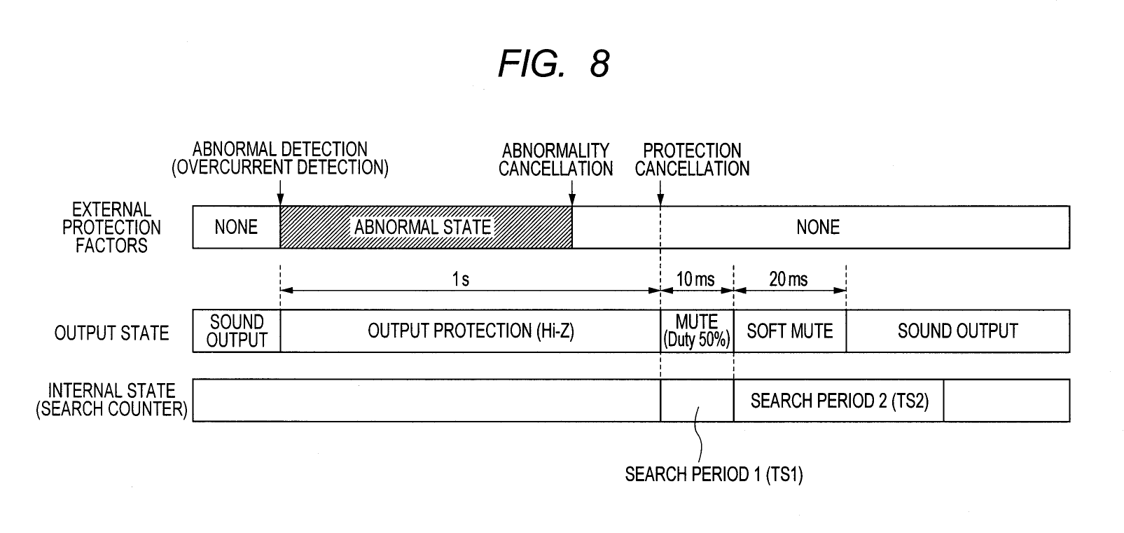

FIG. 8 is an explanatory diagram showing an example of the search period 1 (TS1) and the search period 2 (TS2).

Although the diagram shows an example that the protection time is 1 [s], the mute period is 10 [ms], and soft mute cancellation period is 20 [ms], the invention is not limited to the case.

As shown in the diagram, when overcurrent is detected due to occurrence of the abnormal state, an output of the driving apparatus 2 becomes a high-impedance state (Hi-Z) only for protection time, and the protection state is obtained. When the abnormality is removed and the protection state is cancelled, the driving apparatus 2 shifts to normal operation. After start of the normal operation, the mute period and the soft mute period follow, and a normal sound output state is obtained. At this time, the overcurrent protection circuit 12 sets the same period as the mute period after cancellation of the protection state as the search period 1, monitors whether overcurrent occurs due to powering fault or earth fault, and counts the number of times of detecting the overcurrent in the period. The overcurrent protection circuit 12 sets a predetermined period after lapse of the mute period (search period 1) as the search period 2, monitors whether overcurrent occurs due to the low-impedance state or the like such as short-circuiting across the load, and counts the number of times of detecting the overcurrent in the period.

Next, optimization of the protection operation according to the number of detection times in the search periods 1 and 2 will be described.

As described above, the cause of overcurrent detection in the search period 1 is considered as the powering fault state or the earth fault state, and the possibility that the abnormal state is cancelled within protection time of a few seconds is low. In the case where overcurrent is detected successively in the search period 1 and the abnormal state is not cancelled, in a manner similar to the first embodiment, the overcurrent protection circuit 12 performs a control of extending the protection time. On the other hand, the cause of overcurrent detection in the search period 2 is considered as the low-impedance state across the load or the excessive input, so that occurrence of overcurrent can be suppressed by lowering the output level of sound from the speaker 2. In the case where overcurrent is detected successively in the search period 2 and the abnormal state is not cancelled, the overcurrent protection circuit 12 performs a control of lowering the output level of a signal for driving the speaker 2.

A concrete control method by the overcurrent protection circuit 12 related to the protection operation will be described in detail below.

First, when the current detecting unit 101_A or 101_B detects overcurrent, in a manner similar to the first embodiment, the control logic circuit 108 outputs the protection start signal 53 to the sequence counter unit 123 and stops the operation of the output unit 30_A and 30_B via the pre-drivers 201 to 204. The sequence counter unit 123 which receives the protection start signal 53 starts counting the protection time 1 by using the timer unit 1231 by a method similar to that of the first embodiment. After completion of the measurement, the sequence counter unit 123 outputs the restorable signal 54 and starts measuring the search period 1 by using the timer unit 1231. For example, the sequence counter unit 123 refers to the register 106 in which time information is set, and presets it as protection time 1 into the timer unit 1231. The timer unit 1231 performs the measurement of the preset time.

The following processes will be described in two cases; the case where overcurrent is detected in the search period 1, and the case where overcurrent is not detected in the search period 1 but is detected in the search period 2.

First, in the case where overcurrent is generated again in the search period 1, the protection start signal 53 is output from the control logic circuit 108. The counter unit 1232 in the sequence counter unit 123 counts the number of detection times and holds information of the number of detection times. For example, in the case where overcurrent is detected again in the search period 1, the counter unit 1232 counts the number of detection times, and holds the information of the number of detection times “twice”. After that, the driving apparatus 2 shifts again to the protection operation state and, after lapse of predetermined protection time, returns to the normal operation mode. When overcurrent is detected in the search period 1 after the restoration, the counter unit 1232 counts the number of detection times and updates information of the number of detection times to “three times”. The operation is repeatedly executed until the abnormal state is cancelled. When the number of detection times held reaches N times, the sequence counter unit 123 changes to extend the protection time. Since a concrete method is similar to that in the first embodiment, the description will not be repeated.

Next, the case where overcurrent does not occur in the search period 1 but occurs in the search period 2 will be described.

On completion of measurement of the search period 1 by the timer unit 1231, the sequence counter unit 123 starts measuring the search period 2 by using the timer unit 1231. For example, the sequence counter unit 123 refers to the register 107 in which time information is set, and presets the value as the search period 2 into the timer unit 1231, and the timer unit 1231 measures the preset time. The value of the register 107 can be set from the outside like in the other register 104 and the like.

When overcurrent occurs in the search period 2, the protection start signal 53 is output from the control logic circuit 108, and the counter unit 1232 in the sequence counter unit 123 counts the number of detection times and holds it. For example, when the overcurrent is detected again in the search period 2, the counter unit 1232 counts the number of detection times, sets the number of detection times as “twice”, and holds the information. After that, the program shifts again to the protection operation state and, after lapse of predetermined protection time, returns to the normal operation state. In the case where no overcurrent is detected in the search period 1 after the restoration but the overcurrent is detected in the search period 2, the counter unit 1232 counts the number of detection times as “three times” and updates the information of the number of detection times. The operation is repeated until the abnormal state is cancelled. When the number of detection times held reaches a predetermined number of times, the control logic circuit 108 regulates the output level of a signal for driving the speaker 2 via the output adjusting unit 121 (hereinbelow, also called an “output attenuation state). Concretely, when the number of detection times held in the counter unit 1232 becomes M (M is an integer of 1 or larger), the sequence counter unit 123 supplies a signal 57 indicating that the number of detection times reaches a predetermined number of times to the control logic circuit 108. The control logic circuit 108 receives the signal 57 and instructs the output adjusting unit 121 to regulate the output level of a signal for driving the speaker 2. The output adjusting unit 121 which receives the instruction regulates the output level of the signal for driving the speaker 2 by, for example, adjusting the gain of the amplifier unit 411 or adjusting a change in the pulse width of the drive signal 51 generated by the PWM control unit 412. For example, when the output adjusting unit 121 lowers the gain of the amplifier unit 411, the voltage level of the amplified sound signal 56 which is supplied to the PWM control unit 412 drops, so that variations in the pulse width of the drive signal 51 generated by the PWM control unit 412 are suppressed. As a result, the voltage level across the speaker 2 decreases, and the current flowing in the MOS transistors 301 to 304 decreases. When the output adjusting unit 121 regulates the fluctuations in the pulse width at the time of fluctuations in the pulse width by the PWM control unit 412, the drive signal 51 in which variations in the pulse width are suppressed is generated. As a result, the voltage level across the speaker 2 decreases, and the current flowing in the MOS transistors 301 to 304 decreases. The regulation of the output level of a drive signal by the output adjusting unit 121 may be realized by controlling the amplifier unit 411 and/or the PWM control unit 412.

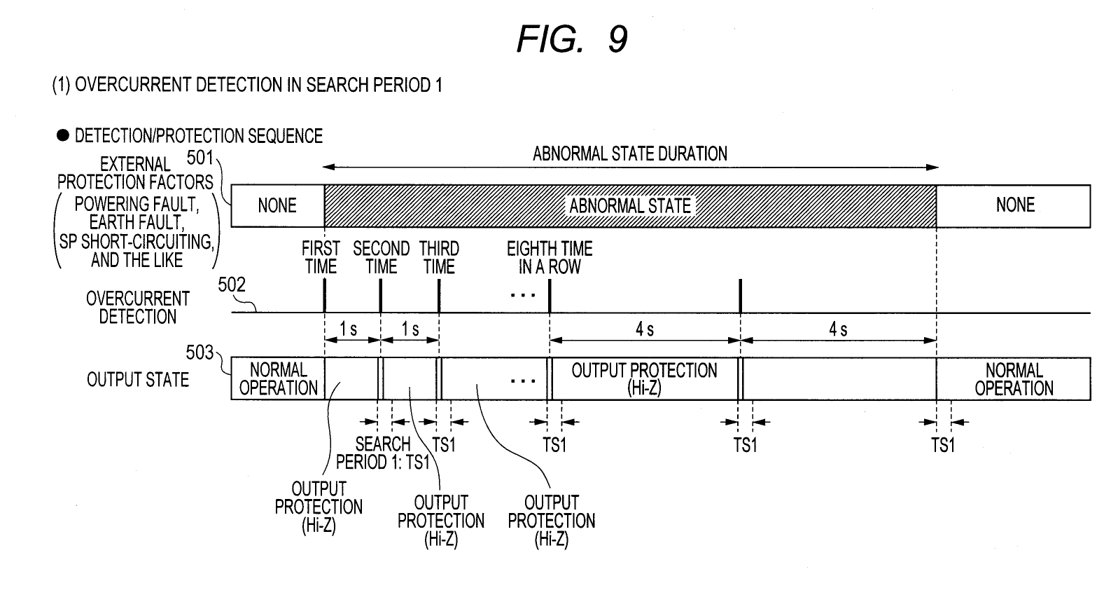

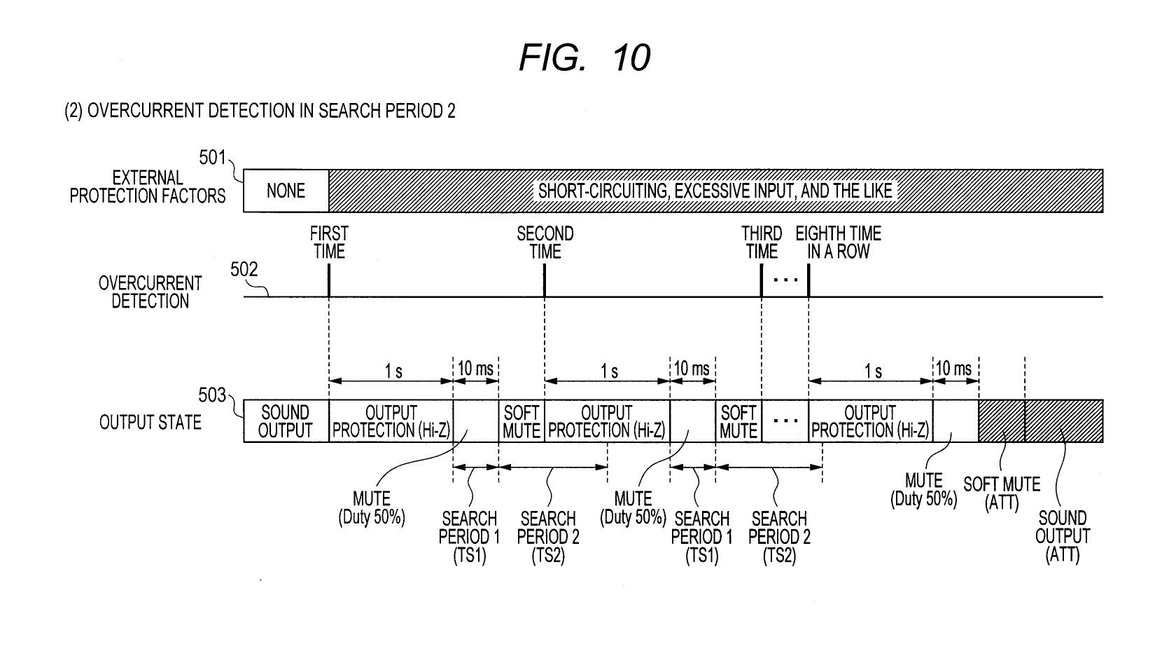

FIGS. 9 and 10 show examples of the sequence at the time of overcurrent detection in the driving apparatus 2.

FIG. 9 is an explanatory diagram showing a sequence in the case where overcurrent detection is performed in the search periods 1 (TS1).

Reference numeral 501 indicates the presence or absence of an abnormal state such as powering fault, earth fault, short-circuit across load terminals, or the like. Reference numeral 502 indicates the timing of overcurrent detection according to the presence/absence of the abnormal state. Reference numeral 503 indicates the output state of the driving apparatus 2 according to the presence/absence of the abnormal state. Although the diagram shows, as an example, the case where the protection time 1 is 1 [s] and the protection time 2 is 4 [s], the invention is not limited to the case.

As shown in the diagram, by the overcurrent detection in the search periods 1 (TS1), shift to the protection operation state of one second and restoration to the normal operation are repeatedly executed. After the overcurrent detection in the search period TS1 of the eighth time, the protection time of the protection operation state is changed from one second to four seconds.

In the case where no abnormal state occurs in the search period 1 (TS1), the mute period having a duty 50% is equivalent to the search period 1 (TS1). However, in the case where an abnormal state occurs in the search period 1 (TS1), the output circuit 30_A or 30_B has high impedance at this time point, and the mute period of duty 50% is cancelled.

FIG. 10 is an explanatory diagram showing a sequence in the case where overcurrent detection is performed in the search period 2 (TS2).

Although the diagram shows the case where the protection time 1 is 1 [s] and the mute period is 10 [ms] as an example, the invention is not limited to the case.

As shown in the diagram, by the overcurrent detection in the search period 2 (TS2), shift to the protection operation state of one second and restoration to the normal operation are repeatedly executed. After detection of overcurrent in the eighth search period TS2, the apparatus shifts to the output attenuation state.

In the driving apparatus 2 having the overcurrent protection circuit 12 according to the second embodiment, the abnormal state in which overcurrent occurs can be distinguished between the abnormal state such as a powering fault state or an earth fault state and the abnormal state such as a low-impedance state including a short-circuiting across the load or an excessive input state, so that the protection method can be optimized according to the abnormal state. Thus, the driving apparatus 2 contributes to suppression of shortening of the product life of the MOS transistors 301 to 304 and reduction in the frequency of occurrence of abnormal sound in the speaker 2 due to overcurrent generation while having the function of automatic restoration from the overcurrent protection state.

Although the invention achieved by the inventors herein has been concretely described on the basis of the embodiments, obviously, the invention is not limited to the embodiments but can be variously modified without departing from the gist of the invention.

For example, in the first and second embodiments, the case of applying the overcurrent protection circuits 10 and 12 to a system using a speaker as a load has been described as an example. The overcurrent protection circuit can be applied to a system in which a load is driven by a driving element such as a MOS transistor and overcurrent protection is necessary. For example, the invention can be also applied to a motor drive system of a BTL (Bridged Transless) type, a power supply circuit, and the like.

A value can be set in the registers 104 to 107 from a host device on the outside. In the case of a system LSI in which the driving apparatus 1 or 2 has a host device such as a CPU, the internal host device may set the registers 104 to 107.

The signal generating unit 41 according to the second embodiment is not limited to the above-described configuration. For example, in the case of inputting a digital sound signal, the PWM control unit 412 may decode the input sound signal and generate the drive signal 51 on the basis of the decoded signal. In this case, the signal generating unit 41 does not have to have the amplifier unit 411. The output attenuation state is realized by regulating the fluctuation width of the pulse at the time of generating the drive signal 51 in the PWM control unit 412 by the output adjusting unit 121.

Further, in the overcurrent protection circuit 12 according to the second embodiment, the method of extending the protection time by the number of successive times of detection of overcurrent in the search period 1 has been described as an example. The invention is not limited to the method. For example, a method of stopping the operation of the MOS transistors 301 to 304 in the output unit 30_A and 30_B after successive detection, holding the state, and outputting a signal indicative of the successive detection may be also employed. For example, the possibility that the abnormal state such as the powering fault state or the earth fault state occurs at the time of manufacture of the speaker driving system including the driving apparatus 2 is high, and the possibility of occurrence of the abnormal state that the end user uses the system is low. In the powering fault state and the earth fault state which happen at high possibility in manufacture which is not intended to output sound, by holding the stop of operation of the output units 30_A and 30_B, shortening of the life of the MOS transistors 301 to 304 can be more suppressed. Further, by outputting a signal indicating that overcurrent is detected successively, the stop of the operation due to the abnormal state can be notified to the outside. The protection method after successive detection in the search period 1 may be switched. For example, a register in which a value can be set from an external host device may be provided in the overcurrent protection circuit 12, and the protection method after continuous detection in the search period 1 can be switched in accordance with the value of the register between a method of extending the protection time and a method of stopping and holding the operation of the output units 30_A and 30_B. With the configuration, for example, by setting the method of holding the operation stop of the output units 30_A and 30_B at the time of manufacturing the speaker driving system and setting the method of extending the protection time at the time of product shipping, the protection method adapted to the use state can be provided.

What is claimed is:

1. An overcurrent protection circuit comprising:
a current detecting unit that monitors current flowing in a driving element for driving a load and detects current which is equal to or larger than a predetermined threshold; and
a control unit that performs a control for stopping driving of the load for only predetermined protection time in accordance with a detection result of the current detecting unit,
wherein the control unit counts the number of times the detection is performed and changes the predetermined protection time in accordance with the number of detection times.

2. The overcurrent protection circuit according to claim 1, wherein when the number of detection times becomes N times (N is an integer of 1 or larger), the control unit changes to extend the predetermined protection time.

3. The overcurrent protection circuit according to claim 2, wherein when the detection is performed in a search period for monitoring the detection, the control unit counts up the number of detection times.

4. The overcurrent protection circuit according to claim 3, wherein the search period is a predetermined period after lapse of the predetermined protection time.

5. The overcurrent protection circuit according to claim 4, further comprising:
a first register in which predetermined time is set;
a second register in which time longer than the predetermined time in the first register is set; and
a third register in which the search period is set,
wherein the first, second, and third registers can be set from the outside.

6. The overcurrent protection circuit according to claim 5, wherein when the number of detection times is less than N, the control unit determines the predetermined protection time in accordance with a value in the first register and, when the number of detection times becomes N, the control unit determines the predetermined protection time in accordance with a value in the second register.

7. A semiconductor device comprising
a driving element for driving a load, and
an overcurrent protection circuit according to claim 1, for controlling operation of the driving element in accordance with current flowing in the driving element.

8. An overcurrent protection circuit comprising:
a current detecting unit that monitors current flowing in a driving element for driving a load and detects current which is equal to or larger than a predetermined threshold; and
a control unit that controls operation of the driving element in accordance with a detection result of the current detecting unit,
wherein the control unit performs a control for stopping the operation of the driving element for only predetermined protection time when the detection is performed, changes the predetermined time in accordance with the number of times the detection is performed in a first search period provided to stop driving the load after lapse of the predetermined protection time, and adjusts drivability of the driving element in accordance with the number of times the detection is performed in a second search period after lapse of the first search period.

9. The overcurrent protection circuit according to claim 8, wherein when the number of detection times in the first search period becomes N times (N is an integer of 1 or larger), the control unit changes to extend the predetermined protection time.

10. The overcurrent protection circuit according to claim 9, wherein when the number of detection times in the second search period becomes M times (M is an integer of 1 or larger), the control unit performs a control of regulating the drivability of the driving element.

11. The overcurrent protection circuit according to claim 10, wherein the control of regulating the drivability of the driving element is a control of lowering level of a signal which is supplied to the driving element.

12. The overcurrent protection circuit according to claim 10, wherein the control of regulating the drivability of the driving element is a control of reducing fluctuation width of a pulse width of a signal which is supplied to the driving element.

13. The overcurrent protection circuit according to claim 10, further comprising:
a first register in which predetermined time is set;
a second register in which time longer than the predetermined time in the first register is set;
a third register in which the first search period is set; and
a fourth register in which the second search period is set,
wherein the first, second, third, and fourth registers can be set from the outside.

14. The overcurrent protection circuit according to claim 13, wherein when the number of detection times is less than N, the control unit determines the predetermined protection time in accordance with a value in the first register and, when the number of detection times becomes N, the control unit determines the predetermined protection time in accordance with a value in the second register.

15. A semiconductor device comprising
a driving element for driving a load, and
an overcurrent protection circuit according to claim 8, for controlling operation of the driving element in accordance with current flowing in the driving element.
